(19) United States
(12) Patent Application Publication
(10) Pub. No.: US 2003/0229152 A1
(43) Pub. Date: Dec. 11, 2003

(54) Method of treating urethane resin, composition for recycling same, and regeneration method

(75) Inventors: Taro Fukaya, Yokohama-shi (JP); Cao Minh Thai, Yokohama-shi (JP); Shioko Saya, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo, JAPAN

(21) Appl. No.: 10/445,361

(22) Filed: May 27, 2003

(30) Foreign Application Priority Data
May 31, 2002 (JP) 2002-160515

(51) Int. Cl. C08J 11/04

(52) U.S. Cl. 521/49

(57) ABSTRACT

Disclosed is a method of adding a compound having at least one group selected from the group consisting of a carboxyl group, salts thereof, esters thereof and haloformyl groups or an acid anhydride, as a treating agent, to a resin decomposed substance prepared by decomposing a urethane bond of a urethane resin, and adding an epoxy resin or isocyanate compound to the product, to regenerate the resin. According to the present invention, reaction activity in producing a regenerated resin from a urethane resin decomposed substance is appropriately suppressed, and thus regeneration of a urethane resin can be carried out by easy procedures.

### CROSS REFERENCE TO RELATED APPLICATIONS

This application is based upon and claims the benefit of priority from the prior Japanese Patent Application No. 2002-160515, filed May 31, 2002; the entire contents of which are incorporated herein by reference.

### BACKGROUND OF THE INVENTION

1. Field of the Invention

The present invention relates to a technology of recycling a urethane resin. More particularly, the present invention relates to a method of treating a urethane resin giving a resin decomposed substance from which a regenerated resin is easily produced, a treated composition for recycling, and a method of regenerating a resin from the composition.

2. Description of Related Art

Urethane resin has been used widely, for example, as insulation materials of refrigerators, construction materials, cushioning materials and the like. Recently, there has been an enhanced desire for recycling these wastes, and recycling of these wastes has been studied in various industrial fields. However, urethane resins are thermosetting resins having a three dimensional network structure. Therefore, recycling thereof is difficult, and disposals such as reclamation and incineration and the like have been conventionally conducted.

Various reports have long been made on methods of chemically decomposing a urethane resin. Japanese Patent Application Publication (JP-B) No. 42-10634 discloses a method in which a polyurethane foam is decomposed with an amine compound such as an alkanolamine and the like, then, the decomposed substance is separated and recovered. However, it is very difficult to separate an amine compound and a polyol showing excellent compatibility, therefore, this method is not suitable industrially. Japanese Patent Application Laid-Open (JP-A) No. 6-184513 discloses a method in which a polyurethane foam is decomposed using a polyol and aminoethanol as a decomposing agent, and recycled as an adhesive aid. When an urethane foam is decomposed by using an amine singly, there is a problem that a crystal derived from the amine appears, and there is a significant difficulty in regenerating a resin. Even if a polyurethane form is decomposed by other methods than those described above, a large amount of amine is contained in the urethane decomposed substance, and this works as a catalyst in reacting with an isocyanate and/or epoxy resin to regenerate a resin, consequently, the reaction progresses steeply, leading to difficulty in generation of a resin.

As the method of consuming an amine in a decomposed substance for deactivation, there is known a method in which a urethane resin is decomposed with a compound obtained by alcolating an alcohol with an alkali metal, and an alkylene oxide such as propylene oxide or the like is added to the decomposed substance. See, for example, Japanese Patent Application Laid-Open (JP-A) No. 53-6038. However, the decomposed substance obtained in this method contains aurea group-containing compound and/or 2-oxazolidone, and these compounds are decomposed by an alkali metal hydroxide if present in the reaction system, to generate a carbonate salt, causing a significant problem. Japanese Patent No. 3242723 discloses a method in which a hard polyurethane foam is decomposed in a monoalkanolamine having 2 to 3 carbon atoms to obtain a decomposition solution, and an alkylene oxide is added to this solution in the presence of an amine catalyst. However, in this case, even if an amino group in the decomposition solution can be de-activated, the added amine catalyst works also as a catalyst for urethane formation, therefore, an effect of resin decomposition is reduced by half. Since propylene oxide, which is frequently used as the alkylene oxide, is a substance designated as a special inflammable, specific process designs are required.

### BRIEF SUMMARY OF THE INVENTION

Conventionally, although there are methods of decomposing a urethane resin, the resulting decomposed substance is difficult to be regenerated due to an amine present therein, and it is difficult to remove an amine in the decomposed substance. Therefore, there have been great difficulties in decomposition and regeneration of a urethane resin.

The present invention has been accomplished in view of the problems as described above. One of the primary objects of the present invention is to provide a method of treating a urethane resin giving a urethane resin decomposed substance which reactivity in regenerating a resin is suppressed and from which a resin can be easily regenerated; a treated substance, and a method of regenerating a resin.

According to one embodiment of the invention, the method of treating a urethane resin comprises a first step of decomposing a urethane bond of a urethane resin to obtain a resin decomposed substance, and a second step of adding an acid anhydride or a compound having at least one group selected from the group consisting of a carboxyl group, salts thereof, esters thereof, and haloformyl groups, as a treating agent, to the above-mentioned resin decomposed substance.

As production raw materials of regenerated resins, there are provided treated substances comprising reaction products which are obtained by reacting an amino group contained in a resin decomposed substance prepared by decomposing a urethane bond in a urethane resin with an acid anhydride or a compound having at least one group selected from the group consisting of a carboxyl group, salts of a carboxyl group, esters of a carboxyl group, and haloformyl groups; namely compositions for recycling.

According to another embodiment of the invention, the method of regenerating a resin comprises a first step of obtaining a resin decomposed substance in which a urethane bond in a urethane resin is decomposed, a second step of adding an acid anhydride or a compound having at least one group selected from the group consisting of a carboxyl group, salts of a carboxyl group, esters of a carboxyl group and haloformyl groups, as a treating agent, to the above-mentioned resin decomposed substance, and a third step of adding an epoxy resin or isocyanate compound to the composition for regeneration obtained in the second step to produce a resin.

According the present invention, a reaction in producing a regenerated resin from a urethane resin decomposed substance is appropriately suppressed, and a regeneration operation can be conducted easily. Resultantly, recycling of a urethane resin can be promoted.

### BRIEF DESCRIPTION OF THE SEVERAL VIEWS OF THE DRAWINGS

FIG. 1 is a schematic sectional view showing one embodiment of a treating apparatus of carrying out a method of treating a urethane resin.

FIG. 2 is a graph showing the relation between lactic acid addition amount and gel time in regenerating a resin when lactic acid is used as a treating agent for a urethane resin decomposed substance.

FIG. 3 is a graph showing the relation between mixture ratio of a decomposed substance in regenerating a resin and rise time.

### DETAILED DESCRIPTION OF THE INVENTION

In cutting a urethane bond of a urethane resin by a known decomposition method, an amine, that is a compound having an amino group is generated though the extent varies depending on the difference in decomposition methods. When an amino compound is used as a decomposing agent in decomposition, this remains in a urethane resin decomposed substance. For suppressing steep increase in reaction speed in regenerating a resin from a urethane resin decomposed substance owing to an amino group contained in the urethane resin decomposed substance, in the present invention, reactivity ascribable to an amino group in the resin decomposed substance is lowered by using a compound having at least one functional group selected from the group consisting of a carboxyl group, salts thereof, esterified substances thereof and haloformyl groups, or an acid anhydride, as a treating agent, and reacting the amino group and the treating agent.

Further, when the compound used as a treating agent has both the above-mentioned functional group and hydroxyl group, the action of the treating agent causes substantial conversion from an amino group into a hydroxyl group, together with de-activation of an amino group. Conversion into a hydroxyl group from an end amino group of a molecule contained in a resin decomposed substance is an effective factor in forming a bond in regeneration of a resin.

Via the above-mentioned treatment, amino groups in a resin decomposed substance decrease. Further, depending on the kind of a treating agent, an end amino group of a molecule is converted into a hydroxyl group, therefore, a treated substance containing a resulting resin decomposed substance has reactivity more suppressed than that of a non-treated resin decomposed substance, showing an excellent property of generating a resin easily.

The present invention will be illustrated in detail below.

1. Urethane Resin Decomposed Substance

The urethane resin which is to be decomposed may be any urethane resin providing it has a urethane bond, urea bond and the like. Examples thereof include rigid polyurethane foam, flexible polyurethane foam, semi-rigid urethane, urethane elastomer and the like. Further, isocyanurate resin having an isocyanurate bond is also possible to be used.

Used for decomposition of a urethane resin are a chemical decomposition method using a decomposing agent, hydrolysis method, thermal decomposition method and the like, and resin decomposed substances obtained by any decomposition method can be used for application of the invention. Since treatment speed is slow or stable quality is not obtained in decomposition methods other than the chemical decomposition method, the chemical decomposition method is practically advantageous. As the decomposing agent used in the chemical decomposition method, for example, amine compounds, polyol compounds and alkali metal alcoholates thereof, and the like are listed, and listed as the use embodiment are, for example, amine compound alone, polyol compound or metal alcoholate of polyol alone, mixing of amine compound and polyol compound or metal alcoholate of polyol, and the like. The present invention is suitable for application of a resin decomposed substance according to a decomposition method using an amine compound or polyol compound, and particularly, the present invention is suitable when decomposed using an amine compound (using amine compound alone, or mixture of amine compound and polyol compound).

Examples of the amine compound which may be used include monoethanolamine, diethanolamine, triethanolamine, ethylenediamine, tetramethylenediamine, hexamethylenediamine, propanediamine, 2-ethylhexylamine, isopropanolamine, 2-(2-aminoethylamino) ethanol, 2-amino-2-hydroxymethyl-1,3-propanediol, ethylaminoethanol, aminobutanol, n-propylamine, di-n-propylamine, n-amylamine, isobutylamine, methyldiethylamine, cyclohexylamine, piperazine, piperidine, aniline, toluidine, benzylamine, phenylenediamine, xylenediamine, chloroaniline, pyridine, picoline, N-methylmorpholine, ethylmorpholine and pirazole.

Examples of the polyol compound include ethylene glycol, diethylene glycol, propylene glycol, trimethylene glycol, 1,4-butanediol, 1,5-pentanediol, 1,6-hexanediol, polyoxyethylene glycol, polyoxypropylene glycol, glycerin, polyethylene glycol and the like.

Such a decomposing agent is mixed with a urethane resin, and if necessary, heated to a temperature in the range from 100 to 300° C., to obtain a urethane resin decomposed substance. As to the temperature, when lower than this, the decomposition time is too long undesirably. When higher than this, thermal decomposition of a urethane resin itself initiates undesirably. Further, it is preferable to heat the mixture at a temperature from about 150 to 280° C.

2. Treating Agent

By reacting a urethane resin decomposed substance with a treating agent, activity by an amino group contained in the resin decomposed substance is lowered by reactions such as amidation of the amino group, and the like. Used as the treating agent is a compound having at least one functional group selected from the group consisting of a carboxyl group (—COOH), salts thereof, ester group (—CO—O—) and haloformyl groups (—CO—X, wherein X represents a halogen) or an acid anhydride. When the treating agent is a compound having a plurality of the above-mentioned functional groups, the functional groups may be the same or different. A plurality of different compounds may be used in combination as the treating agent. The molecule structure of parts other than the functional group of the treating agent is not particularly restricted providing it does not disturb the action of the functional group.

Listed as compounds having a carboxyl group as a functional group (namely, carboxylic acid) are, for example, saturated mono-valent carboxylic acids such as formic acid, acetic acid, propionic acid, butyric acid; unsaturated carboxylic acids such as propiolic acid, oleic acid, acrylic acid, methacrylic acid, oxalic acid, maleic acid, fumaric acid, itaconic acid, malonic acid, succinic acid and adipic acid and compounds having two or more carboxyl groups; aromatic carboxylic acids having a benzene ring such as phthalic acid, and the like. Listed as the acid anhydride are anhydrides of the above-mentioned carboxylic acid, for example, acetic anhydride and propionic anhydride, butyric anhydride, phthalic anhydride, maleic anhydride and the like. Compounds having a carboxyl group and being anhydrides may also be used, and examples thereof include trimellitic anhydride, cyclopentanetetracarboxylic dianhydride, and the like. Acid anhydride-based cross-linking agents commercially available in general as the hardener for an epoxy resin, for example, methylhexahydrophthalic anhydride, hexahydrophthalic anhydride and the like can also be used.

Selection of the treating agent is not defined indiscriminately since it depends on the use of the regenerated resin. However, when the decomposed substance is utilized as a decomposed material which is in liquid form under room temperature (for example polyol used for the regeneration into a urethan resin), those having only one carboxyl group in the molecule are preferable. The reason for this is that poly-functional compounds increase the molecular weight, causing a possibility of disturbing in regeneration (compounds that has an unsaturated carbon linkage such as acrylic acid and metha acrylic acid are excluded, however, since in this case it is likely that polymerization proceeds and the molecular weight increases). In contrast, when it is wished to render a resin decomposed substance into solid (for instance, usage as amolding material), it is desirable to use compounds that are poly-functional or have an unsaturated carbon linkage. With such compounds, a resin decomposed substance will be made solid after the treatment, and therefore it can be easily utilized as a molding material.

The salt of a compound having a carboxyl group (carboxylate) is an alkali metal salt or alkaline earth metal salt of the above-mentioned carboxylic acid, and examples thereof include sodium salts, magnesium salts, potassium salts, calcium salts and the like of carboxylic acids. Listed as the preferable sodium salts are, for example, sodium formate, sodium acetate, sodium propionate, sodium oleate, sodium acrylate and the like, and listed as the preferable calcium salts are, for example, calcium acetate, calcium propionate and the like.

As the compound (ester compound) having an ester group (alkoxycarbonyl group, allyloxycarbonyl group, acyloxy group) as a functional group, those obtained by esterifying the above-mentioned compounds having a carboxyl group are listed. For example, examples of those obtained by esterifying acetic acid include methyl acetate, ethyl acetate, n-propyl acetate, n-butyl acetate, n-pentyl acetate, isopentyl acetate, benzyl acetate, phenyl acetate and the like, and those obtained by esterifying other carboxylic acids are likewise listed. Typical ester compounds include ethyl esters such as ethyl formate, ethyl acetate, ethyl propionate, ethyl n-butyrate, ethyl benzoate; and di-n-butyl maleate, diallyl phthalate, diethyl succinate, bis(2-hydroxyethyl) terephthalate, bis(3,5,5-trimethylhexyl) phthalate and the like. Alternatively, lactone compounds obtained by esterification of a carboxyl group and a hydroxyl group in the molecule may also be permissible, and examples thereof include α-lactones, β-lactones, γ-lactones, δ-lactones, ε-lactones and the like, and any of them can be used. For example, listed are 4-butyrolactone, ε-caprolactone, γ-decalactone, glucono-δ-lactone, L-glucone-1,5-lactone, lactone γ-octanoate, β-propiolactone, D(+)-glucono-3,6-lactone and the like.

As the compound (halogenated acyl) having a haloformyl group (—CO—X, wherein X represents a halogen) as a functional group, any of those derived from compounds having a carboxyl group can be used. Examples thereof include acetyl chloride, acryloyl chloride, o-anisoyl chloride, benzoyl chloride, 4-tert-butylbenzoyl chloride, n-butylyl chloride, chloroacetyl chloride, lauroyl chloride, propionyl chloride, p-tolyoyl chloride and the like.

When those having further a hydroxyl group in the molecule are used as a treating agent, the molecule end of an amine in a resin decomposed substance can be converted from an amino group into a hydroxyl group, therefore, they can be utilized like polyols. As such compounds, for example, compounds classified as hydroxy acids such as hydroxybenzoic acid and the like are listed, and there are a lot of natural substances classified into this group. For example, glycolic acid, lactic acid, malic acid, tartaric acid, citric acid, saccharic acid, gluceric acid, gluconic acid, salicylic acid and the like are listed. These substances have optical isomers because it their structures, however, it is not necessary to take them into consideration. For example, any of D form, L form and DL form of lactic acid may be used without problems. Of the above-mentioned compounds, those having one carboxyl group and one hydroxyl group such as glycolic acid and lactic acid are particularly preferably used. If the number of functional groups at the end varies, there is a possibility of change in physical properties in regenerating a resin. Lactic acid can be purchased at low cost, and further, basically provides no problems such as environmental pollution and the like, therefore, lactic acid is one of candidates for industrially important treating agents.

3. Addition Amount and Reaction Conditions of Treating Agent

The desirable ratio of reacting a treating agent differs depending on the number of functional groups and the equivalent of a compound. When the treating agent is a compound having only one carboxyl group or an acid anhydride (for example, acetic anhydride, propionic anhydride or the like) obtained by mutual bonding of molecules having only one carboxyl group by dehydration, the treating agent can be added without specific restriction. Preferably, the amount of the treating agent based on 100 parts by weight of a urethane resin decomposed substance is from 1 to 100 parts by weight, more preferably from 5 to 50 parts by weight. It is desirable to add it at a stoichiometric ratio just causing reaction with amino groups in the resin decomposed substance. The amount of an amino group in the resin decomposed substance can be checked as an amine value determined according to known measuring methods (for example, JIS K 7237). When the addition amount of a treating agent is too small, an amino group cannot be sufficiently inactivated. When the addition amount of a treating agent is larger than the stoichiometric ratio, excess portion acts as a diluting agent, and no problems occur, however, it is desirable to avoid extreme excess amount since there is a possibility of disturbing the cross-linking reaction of an epoxy resin or isocyanate added later for regeneration of a resin.

When a compound having two or more of the above-mentioned functional groups or an acid anhydride (for example, phthalic anhydride) obtained by intra-molecule dehydration is added as a treating agent, it is necessary to pay attention to its addition amount. Preferably, the addition amount is from 0.5 parts by weight to 30 parts by weight based on 100 parts by weight of a urethane resin decomposed substance. The addition amount is from 0.1 to 1.2, more preferably from 0.3 to 1.0, further preferably from 0.5 to 1.0 when represented by the ratio based on the stoichiometric amount just causing reaction of all amino groups. When the addition amount of a treating agent is too large, increase in viscosity or a cross-linking reaction occurs in the resin decomposed substance. When too small, to the contrary, sufficient effect of decomposing a urethane resin is not obtained.

The object of addition a treating agent is to control the speed of the reaction of a urethane resin decomposed substance and a regenerating agent (epoxy resin or isocyanate) in production of a regenerated resin from a resin decomposed substance carried out thereafter. Therefore, it is necessary that the addition of a treating agent is effected before addition of a regenerating agent and a sufficient reaction with a resin decomposed substance is conducted. When a regenerating agent is added simultaneously with addition of a treating agent or added when a sufficient reaction is not yet conducted, the reaction speed cannot be decreased, and a sufficient effect cannot be obtained.

The temperature at which a treating agent is allowed to act on a resin decomposed substance is appropriately set, depending on demands, within the range from room temperature to about 300° C. When the temperature is higher than 300° C., a phenomenon that the main chain of a polymer contained in a resin decomposed substance is cut, and the like is likely to occur, and cause a change in its properties. This temperature is preferably from 80 to 250° C., further preferably from 100 to 250° C. When the temperature is lower than 80° C., evaporation of water generated by the reaction is not promoted, and the reaction delays. Though the treatment time varies depending on the kind of a treating agent and the treatment temperature, it could be confirmed that the reaction can be completed generally in the range from 10 minutes to 3 hours when the treatment is conducted at temperatures from about 80 to 250° C. When the treatment time is shorter, a sufficient reaction is not achieved. When heated for an excessively longer period of time, the properties of a resin decomposed substance change due to the influence of thermal decomposition.

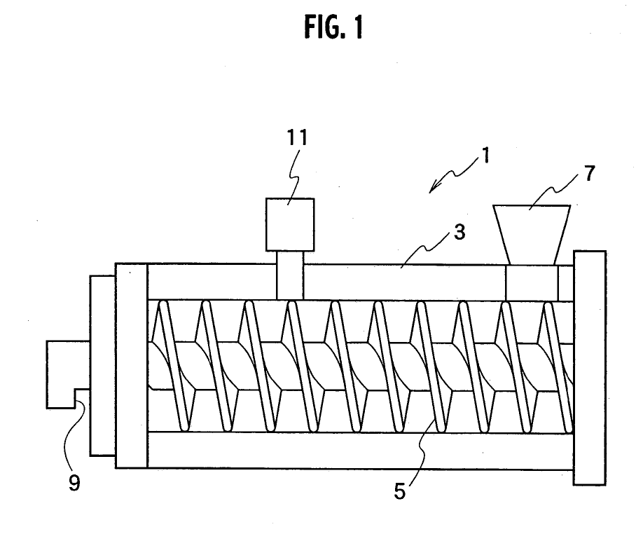

Decomposition of a urethane resin and treatment with a treating agent can be efficiently conducted continuously if conducted using, for example, extruder 1 as shown in FIG. 1. Extruder 1 has cylinder portion 3 equipped with a temperature controllable heater, rotation controllable screw 5 in contact with the inner wall of cylinder portion 3, input port 7 provided at one end of cylinder portion 3, discharge port 9 provided at another end of cylinder portion 3, and a supply port 11 provided between input port 7 and discharge port 9. A heater of cylinder portion 3 can be set so that temperatures of cylinder portion 3 vary locally, and for example, heating temperature can be changed before and after supply port 11.

The temperature of cylinder portion 3 is set at the decomposition temperature of a urethane resin, and the rotation speed of screw 5 is set so that the time during which an input substance into the extruder progresses from input port 7 to supply port 11 by rotation of screw 5 corresponds to the time required for the decomposition of a urethane resin. When a urethane resin and a decomposing agent are input through input port 7, the decomposition of the urethane resin initiates, and the resin moves toward the direction of discharge port 9. A treating agent is supplied through supply port 11 to a urethane resin decomposed substance, and a treated substance after completion of treatment is discharged from discharge port 9.

When extruder 1 is used, a mixture of a urethane resin and a decomposing agent is kneaded between the inner wall of extruder 1 and screw 5. Since decomposition treatment can be effected under condition closely adhered to the inner wall of cylinder portion 3 and the surface of screw 5, conduction of heat for heating can be effected quickly. By discharge from extruder 1, cooling after the decomposition treatment can also be conducted quickly. Therefore, when extruder 1 is used, the decomposition treatment of a urethane resin can be progressed while easily and correctly controlling the temperature of a reaction product. In contrast, for example, an article such as a pan shows poor conduction of heat, and needs a longer period of time for raising and lowering temperature. Further, quick discharge like in extruder 1 is not obtained, and cooling needs a longer period of time.

4. Regenerant: Epoxy Resin and Isocyanate Compound

The epoxy resin and isocyanate compound used as a regenerant for regenerating a resin from a urethane resin decomposed substance can be selected from known compounds and used, depending on demands. The epoxy resin may be a compound having two or more epoxy groups in one molecule and is not particularly restricted. Specific examples thereof include bisphenol A type epoxy resin, bisphenol F type epoxy resin, phenol novolak type epoxy resin, cresol novolak type epoxy resin, naphtol-based novolak type epoxy resin, novolak type epoxy resin of bisphenol A, naphthalenediol type epoxy resin, alicyclic epoxy resin, epoxy resin derived from tri or tetra(hydroxyphenyl) alkane, bishydroxybiphenyl-based epoxy resin, epoxidized substance of phenolaralkyl resin, and the like. These epoxy compound can be used singly or in admixture of two or more. The isocyante compound may be one having two or more isocyanate groups in one molecule, and is not particularly restricted. Specific examples thereof include diisocyanate compounds such as 1,5-naphthalene diisocyanate, 4,4′-diphenylmethane diisocyanate, 4,4′-diphenyldimethylmethane diisocyanate, 4,4′-dibenzyl isocyanate, dialkyldiphenylmethane diisocyanate, tetraalkyldiphenylmethane diisocyanate, 1,3-phenylene diisocyanate, 1,4-phenylene diisocyanate, tolylene diisocyanate, butane-1,4-diisocyanate, hexamethylene diisocyanate, 2,2,4-trimethylhexamethyelene diisocyanate, cyclohexane-1,4-diisocyanate, xylylene diisocyanate, isophorone diisocyanate, pyridine diisocyanate, dicyclohexylmethane-4,4-diisocyanate, methylcyclohexane diisocyanate and the like, poly-functional isocyanate compounds such as dimethylenetriphenylmethane tetraisocyanate, triphenylmethane triisocyanate, polymethylenepolyphenyl polyisocyanate and the like; addition products of polyols such as glycerin, trimethylolpropane and the like with the above-mentioned isocyanate compounds, and the like. These isocyanate compounds may be use singly or in admixture of two or more.

5. Regeneration of Resin

A liquid composition for regeneration after treatment of a urethane resin decomposed substance with the above-mentioned treating agent is regenerated as a resin by appropriate molding after mixing of the above-mentioned regenerating agent. The molding method is appropriately determined depending on demands.

For example, when a liquid epoxy resin is used as a regenerating agent, a treated substance and an epoxy resin are mixed using an all around mixer and the like, the mixture is cast into a mold at temperatures from room temperature to 200° C., and hardened by heating for about 1 hour to over night, to obtain a regenerated resin. In mixing, organic particles or inorganic particles and the like may be added as a filler, or a plasticizer, coupling agent and the like may be compounded.

When a urethane foam is produced, an isocyanate compound is added to and mixed with a treated substance, and bond formation and foaming progress at a speed corresponding to temperature, therefore, a mixture is input into a mold at temperatures of from about room temperature to 80° C. and molded. If necessary, a polyol compound which is a urethane resin raw material, and a foaming agent, foam controlling agent, filler, catalyst and the like may be added to a treated substance.

When a solid substance obtained by solidifying a treated substance of a urethane resin decomposed substance by cooling is used, this solid substance, solid epoxy resin or isocyanate compound is finely ground and mixed with a wood powder, inorganic filler and the like, and molded under heat and pressure using a press molding machine, to give a molded body. The hardening temperature is advantageously from about 80 to 200° C. in general, though varying depending on the melting point or softening point and the like of a urethane resin decomposed substance, epoxy resin and isocyanate compound used.

### EXAMPLES

The present invention will be illustrated in detail below based on examples.

### Preparation of Urethane Resin Decomposed Substance

Urethane resin decomposed substances A to H described below were prepared.

Decomposed Substance A

A urethane resin which is a refrigerator heat insulation material, and diethanolamine were mixed at a weight mixture ratio of 3.2:1 and input into a twin-screw extruder heated at 230° C., and reacted by mixing under heat for 3 minutes, to obtain liquid viscous at room temperature. This urethane resin decomposed substance A had an amine value of 159 mg KOH/g.

Decomposed Substance B

A urethane decomposed substance was produced under the same conditions as in the production of urethane resin decomposed substance A except that the heating temperature was 300° C. and the mixing time was 2 minutes. Liquid viscous at room temperature was obtained. This urethane resin decomposed substance B had an amine value of 165 mg KOH/g.

Decomposed Substance C

A urethane decomposed substance was produced under the same conditions as in the production of urethane resin decomposed substance A except that the heating temperature was 350° C. and the mixing time was 2 minutes. Liquid viscous at room temperature was obtained, however, vapor was blown out significantly from the outlet of the extruder, and resultantly, discharge of a decomposed substance was also unstable. This urethane resin decomposed substance C had an amine value of 168 mg KOH/g.

Decomposed Substance D

A urethane resin which is a cushion material, and monoethanolamine were mixed at a weight mixture ratio of 2.5:1 and input into a twin-screw extruder heated at 170° C., and reacted by mixing under heat for 3 minutes, to obtain liquid viscous at room temperature. This urethane resin decomposed substance D had an amine value of 139 mg KOH/g.

Decomposed Substance E

A urethane decomposed substance was produced under the same conditions as in the production of urethane resin decomposed substance D except that the heating temperature was 150° C. and the mixing time was 5 minutes. Liquid viscous at room temperature was obtained. This urethane resin decomposed substance E had an amine value of 140 mg KOH/g.

Decomposed Substance F

A urethane decomposed substance was produced under the same conditions as in the production of urethane resin decomposed substance D except that the heating temperature was 100° C. and the mixing time was 20 minutes. Liquid viscous at room temperature was obtained. This urethane resin decomposed substance F had an amine value of 133 mg KOH/g.

Decomposed Substance G

A urethane resin which is a refrigerator heat insulation material, and diethanolamine and polyethylene glycol were mixed at a weight mixture ratio of 3:1:2 and input into a single-screw extruder heated at 250° C., and reacted by mixing under heat for 3 minutes, to obtain liquid viscous at room temperature. This urethane resin decomposed substance G had an amine value of 101 mg KOH/g.

Decomposed Substance H

A urethane resin which is a refrigerator heat insulation material, and an alcoholate prepared by reacting 200 parts by weight of metal sodium with 100 parts by weight of polyethylene glycol (#200) were mixed at a weight mixture ratio of 3:1 and input into a single-screw extruder heated at 250° C., and reacted by mixing under heat for 3 minutes, to obtain a decomposed substance which was washed with water to retrieve only an organic layer, giving liquid viscous at room temperature. This urethane resin decomposed substance H had an amine value of 89.2 mg KOH/g.

Production conditions for the above-mentioned urethane resin decomposed substances are summarized in Table 1.

TABLE 1

| Urethane Resin | | | | | | | | |
|---|---|---|---|---|---|---|---|---|
| Decomposed | | | | | | | | |
| Substance | A | B | C | D | E | F | G | H |
| Urethane Resin | Refrigerator | Refrigerator | Refrigerator | Cushion | Cushion | Cushion | Refrigerator | Refrigerator |
| Decomposing Agent | Diethanol | Diethanol | Diethanol | Monoe | Monoe | Monoe | Diethanol | Polyeth |
| (1) | amine | amine | amine | thano | thano | thano | amine | ylene |
| | | | | lamine | lamine | lamine | | glycol |
| | | | | | | | | #200 |
| Decomposing Agent | — | — | — | — | — | — | Polyethylene | Metal |
| (2) | | | | | | | glycol | sodium |
| | | | | | | | #200 | |
| Decomposition | 3.2/1/0 | 3.2/1/0 | 3.2/1/0 | 2.5/1/0 | 2.5/1/0 | 2.5/1/0 | 3/1/2 | 3/0.3/0.67 |
| Ratio: | | | | | | | | |
| Urethane/Decom- | | | | | | | | |
| posing Agent | | | | | | | | |
| (1)/Decomposing | | | | | | | | |
| Agent (2) | | | | | | | | |
| Decomposition | 230 | 300 | 350 | 170 | 150 | 100 | 250 | 250 |
| Temperature (° C.) | | | | | | | | |
| Decomposition | 3 | 2 | 2 | 3 | 5 | 20 | 3 | 3 |
| Time (min.) | | | | | | | | |
| Amine Value (mg | 159 | 165 | 168 | 139 | 140 | 133 | 101 | 89.2 |
| KOH/g) | | | | | | | | |

### Example 1

A mixture of 100 parts by weight of urethane decomposed substance A and acetic acid of an amount shown in Table 2 was reacted at 150° C. for 60 minutes using an oil bath. The resulted reaction product and bisphenol A type epoxy resin (Product No.: EP4100E, manufactured by Asahi Denka Kogyo K. K.) were mixed at a weight mixture ratio of 1/1, and heated in an oil bath at 100° C., and gel time was measured. The results are shown in Table 2.

As apparent from Table 2, those obtained with acetic acid treatment show significantly elongated gel time as compared with a resin decomposed substance obtained with out acetic acid treatment.

TABLE 2

| Urethane resin | Part by weight | |
|---|---|---|
| decomposed substance | of acetic acid | Gel time (mIN.) |
| A | 0 | 12 |
| A | 10 | 18 |
| A | 20 | 35 |
| A | 30 | 54 |

### Example 2

30 parts by weight of the treated substance in Example 1 obtained by treating urethane resin decomposed substance A with acetic acid, and 56 parts by weight of a polyol mixture (hydroxyl group value=381 mg KOH/g) used as a raw material of a urethane resin for refrigerator heat insulation material were mixed, and to this was added 90 parts by weight of a polymeric MDI-based isocyanate mixture (% NCO=31.4) used as a raw material of a urethane resin for refrigerator heat insulation material, and the mixture was stirred at high speed to produce a foam. In this operation, rise time was 2 minutes and 58 seconds.

### Comparative Example 1

A foam was produced under the same conditions as in Example 2 except that urethane resin decomposed substance A which had not been treated with acetic acid was used. In this operation, rise time was 1 minute and 56 seconds, shorter than the rise time in Example 2 where a decomposed substance treated with acetic acid was used.

### Example 3

100 parts by weight of urethane decomposed substance A and 20 parts by weight of acetic anhydride were mixed under heat over night in an oil bath of 40° C., conducting treatment of the urethane decomposed substance. Gel time with epoxy was measured in the same manner as in Example 1, to find that it was 31 minutes.

### Example 4

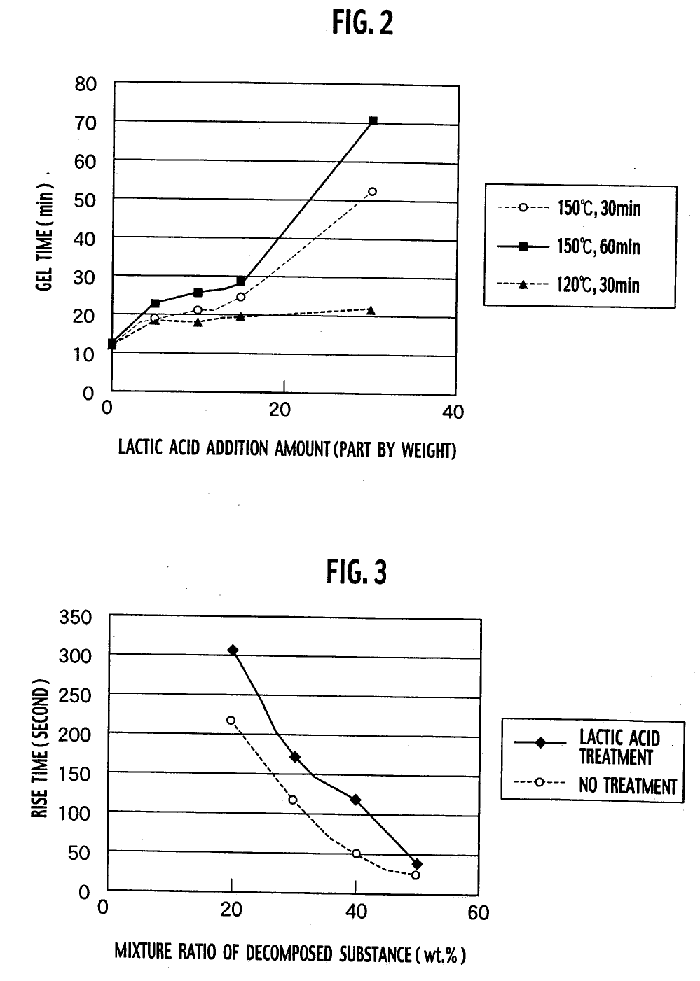

A mixture of 100 parts by weight of urethane decomposed substance A and DL-lactic acid (purity: 90%) of an amount shown in Table 3 was reacted at 80° C. for 180 minutes, 120° C. for30minutes, 150° C. for 30 minutes, 150° C. for 60 minutes, 250° C. for 10 minutes or 300° C. for 10 minutes, using an oil bath. The resulted reaction product and a bisphenol A type epoxy resin (product No.: EP4100E) were mixed at a weight mixture ratio of 1/1, and heated in an oil bath at 100° C., and gel time was measured. The results are shown in Table 3 and FIG. 2.

As apparent from Table 3, those obtained with treatment show significantly elongated gel time as compared with a resin decomposed substance obtained without lactic acid treatment.

TABLE 3

| Lactic acid treatment | Gel time (min.) | | | | |
|---|---|---|---|---|---|
| Temperature/Time | Part by weight of lactic acid | | | | |
| (° C./min.) | 0 | 5 | 10 | 15 | 30 |
| 80/180 | 13 | 18 | 19 | 19 | 25 |
| 150/30 | 12.5 | 19 | 21 | 24.5 | 52 |
| 150/60 | 12 | 23 | 26 | 29 | 71 |
| 120/30 | 13 | 18.75 | 18.5 | 2 | 22 |
| 250/10 | 13 | 20 | 21 | 31 | 66 |
| 300/10 | 12 | 19 | 19 | 28 | 64 |

### Example 5

The treated substance obtained by treating urethane resin decomposed substance A with lactic acid at 150° C. for 60 minutes in Example 4 was mixed with a polyol mixture (hydroxyl group value=381 mg KOH/g) used as a raw material of a urethane resin for refrigerator heat insulation material, at mixture ratio (wt % based on total amount) shown in Table 4, giving 100 parts by weight, and to this was added 90 parts by weight of a polymeric MDI-based isocyanate mixture (% NCO=31.4) used as a raw material of a urethane resin for refrigerator heat insulation material, and the mixture was stirred at high speed to produce a foam.

### Comparative Example 2

Aproduct was obtained in the same manner as in Example 5 excepting that urethane resin decomposed substance A had not been treated with lactic acid and used, as Comparative Example 2.

The relationship between the mixture ratio of the decomposed substance and rise time in Example 5 and Comparative Example 2 is shown in Table 4 and FIG. 3.

As apparent from Table 4, those obtained with lactic acid treatment show significantly elongated rise time showing reaction time, and thus could suppress reactivity, as compared with that obtained without treatment.

TABLE 4

| Mixture Ratio of | Rise Time (second) | |
|---|---|---|
| Decomposed Substance | Example 5 | Comparative Example 2 |
| 20 wt. % | 304 | 215 |
| 30 wt. % | 171 | 116 |
| 40 wt. % | 117 | 51 |
| 50 wt. % | 41 | 26 |

### Example 6

100 parts by weight of urethane decomposed substance B and 10 parts by weight of lactic acid were treated at 150° C. for 60 minutes to obtain a reaction product of which gel time was measured in the same manner as in Example 4. The gel time was 19.75 minutes.

### Comparative Example 3

A product was obtained under the same conditions as in Example 6 except that urethane decomposed substance B which had not been treated with lactic acid was used, and the gel time of the product was measured to find that it was 10.75 minutes. This gel time was shorter as compared with Example 6.

### Example 7

100 parts by weight of urethane decomposed substance C and 10 parts by weight of lactic acid were treated at 150° C. for 60 minutes to obtain a reaction product of which gel time was measured in the same manner as in Example 4. The gel time was 21.25 minutes.

### Comparative Example 4

A product was obtained under the same conditions as in Example 7 except that urethane decomposed substance E which had not been treated with lactic acid was used, and the gel time of the product was measured to find that it was 13 minutes. This gel time was shorter as compared with Example 7.

### Example 8

100 parts by weight of urethane resin decomposed substance D and 5 parts by weight of lactic acid were reacted at 150° C. for 60 minutes. 10 parts by weight of this product obtained by treating urethane decomposed substance D with lactic acid and 90 parts by weight of a polyol mixture (the hydroxyl group value being 56 mg KOH/g, and containing a foaming agent and a foam controlling agent) which is used as a raw material of a urethane resin for cushion material were mixed, and to this was added 25 parts by weight of a polymeric MDI-based isocyanate mixture (% NCO=44.5) which is used as a raw material of a urethane resin for cushion material, and the mixture was stirred at high speed to produce a foam. The rise time was 3 minutes and 40 seconds. A flexible foam could be obtained.

### Comparative Example 5

A foam was tried to be produced under the same conditions as in Example 8 except that the urethane decomposed substance D which had not been treated with lactic acid was used, as a result, a phenomenon that shrinking occurs after once foaming was observed, and a satisfactory foam could not be obtained. The rise time was 2 minutes and 30 seconds.

### Example 9

100 parts by weight of urethane resin decomposed substance E and 10 parts by weight of lactic acid were treated at 150° C. for 60 minutes to obtain a reaction product which was mixed with a bisphenol A type epoxy resin (Product No.: EP4100E, manufactured by Asahi Denka Kogyo K. K.) at a weight mixture ratio of 1/1, and heated in an oil bath at 100° C., and gel time was measured. The gel time was 19.25 minutes.

### Comparative Example 6

A product was obtained under the same conditions as in Example 9 except that urethane decomposed substance E which had not been treated with lactic acid was used, and the gel time of the product was measured to find that it was 13 minutes.

### Example 10

100 parts by weight of urethane resin decomposed substance F and 10 parts by weight of lactic acid were treated at150° C. for 60 minutes to obtain a reaction product of which gel time with epoxy resin was measured in the same manner as in Example 9. The gel time was 21 minutes.

### Comparative Example 7

A product was obtained under the same conditions as in Example 9 except that urethane decomposed substance F which had not been treated with lactic acid was used, and the gel time of the product was measured to find that it was 12.5 minutes.

### Example 11

100 parts by weight of urethane resin decomposed substance G and 10 parts by weight of DL-lactic acid (purity: 90%) were mixed, and heated at 150° C. for 1 hour using an oil bath. The resulted liquid was mixed with a polyol mixture (hydroxyl group value=381 mg KOH/g) used as a raw material of a urethane resin for refrigerator heat insulation material, at mixture ratio (wt. % based on total amount) shown in Table 5, giving 100 parts by weight, and to this was added 90 parts by weight of a polymeric MDI-based isocyanate mixture (% NCO=31.4) used as a raw material of a urethane resin for refrigerator heat insulation material, and rise time in this operation was measured. The resulted value is shown in Table 5.

### Comparative Example 8

100 parts by weight of urethane resin decomposed substance G was mixed with a polyol mixture (hydroxyl group value=381 mg KOH/g) used as a raw material of a urethane resin for refrigerator heat insulation material, at mixture ratio (wt. % based on total amount) shown in Table 5, and to 100 parts by weight of the resulted mixture was added 90 parts by weight of a polymeric MDI-based isocyanate mixture (% NCO=31.4) used as a raw material of a urethane resin for refrigerator heat insulation material, and the mixture was stirred at high speed to produce a foam, and rise time in this operation was measured. The resulted value is shown in Table 5.

TABLE 5

| Mixture | Rise time (second) | |
|---|---|---|
| Ratio of Decomposed Substance | Example 11 | Comparative Example 8 |
| 20 wt % | 431 | 303 |
| 30 wt % | 239 | 166 |
| 40 wt % | 165 | 70 |
| 50 wt % | 57 | 45 |

### Example 12

100 parts by weight of urethane resin decomposed substance H and 10 parts by weight of DL-lactic acid (purity: 90%) were mixed, and heated at 150° C. for 1 hour using an oil bath. The resulted liquid was mixed with a polyol mixture (hydroxyl group value=381 mg KOH/g) used as a raw material of a urethane resin for refrigerator heat insulation material, at mixture ratio (wt. % based on total amount) shown in Table 6, giving 100 parts by weight, and to this was added 90 parts by weight of a polymeric MDI-based isocyanate mixture (% NCO=31.4) used as a raw material of a urethane resin for refrigerator heat insulation material, and the mixture was stirred at high speed to produce a foam, and rise time in this operation was measured. The resulted value is shown in Table 6.

### Comparative Example 9

100 parts by weight of urethane resin decomposed substance H was mixed with a polyol mixture (hydroxyl group value=381 mg KOH/g) used as a raw material of a urethane resin for refrigerator heat insulation material, at mixture ratio (wt. % based on total amount) shown in Table 6, and to 100 parts by weight of the resulted mixture was added 90 parts by weight of a polymeric MDI-based isocyanate mixture (% NCO.=31.4) used as a raw material of a urethane resin for refrigerator heat insulation material, and the mixture was stirred at high speed to produce a foam, and rise time in this operation was measured. The resulted value is shown in Table 6.

TABLE 6

| Mixture | Rise time second | |
|---|---|---|
| Ratio of Decomposed Substance | Example 12 | Comparative Example 9 |
| 20 wt % | 540 | 368 |
| 30 wt % | 302 | 207 |
| 40 wt % | 200 | 92 |
| 50 wt % | 73 | 55 |

### Example 13

100 parts by weight of urethane resin decomposed substance A and 10 parts by weight of benzoyl chloride were mixed, and heated at 150° C. for 60 minutes using an oil bath. The product obtained was mixed with a polyol mixture (hydroxyl group value=381 mg KOH/g) used as a raw material of a urethane resin for refrigerator heat insulation material, at mixture ratio (wt. % based on total amount) shown in Table 7. To 100 parts by weight of the resulted mixture was added 90 parts by weight of a polymeric MDI-based isocyanate mixture (% NCO=31.4) used as a raw material of a urethane resin for refrigerator heat insulation material, and the mixture was stirred at high speed to produce a foam, and rise time in this operation was measured. The resulted value is shown in Table 7.

The rise time, which indicates reaction time, elongated significantly, and thus could suppress the reactivity, as compared with that obtained without treatment in Comparative Example 2.

### Example 14

100 parts by weight of urethane resin decomposed substance A and 10 parts by weight of methyl benzoate were mixed, and heated at 150° C. for 60 minutes using an oil bath. The product obtained was mixed with apolyol mixture (hydroxyl group value=381 mg KOH/g) used as a raw material of a urethane resin for refrigerator heat insulation material, at mixture ratio (wt. % based on total amount) shown in Table 7. To 100 parts by weight of the resulted mixture was added 90 parts by weight of a polymeric MDI-based isocyanate mixture (% NCO=31.4) used as a raw material of a urethane resin for refrigerator heat insulation material, and the mixture was stirred at high speed to produce a foam, and rise time in this operation was measured. The resulted value is shown in Table 7.

The rise time, which indicates reaction time, elongated significantly, and thus could suppress reactivity, as compared with that obtained without treatment in Comparative Example 2.

### Example 15

100 parts by weight of urethane resin decomposed substance A and 10 parts by weight of γ-butyrolactone were mixed, and heated at 150° C. for 60 minutes using an oil bath. The product obtained was mixed with a polyol mixture (hydroxyl group value=381 mg KOH/g) used as a raw material of a urethane resin for refrigerator heat insulation material, at mixture ratio (wt. % based on total amount) shown in Table 7. To 100 parts by weight of the resulted mixture was added 90 parts by weight of a polymeric MDI-based isocyanate mixture (% NCO =31.4) used as a raw material of a urethane resin for refrigerator heat insulation material, and the mixture was stirred at high speed to produce a foam, and rise time in this operation was measured. The resulted value is shown in Table 7.

The rise time, which indicates reaction time, elongated significantly, and thus could suppress reactivity, as compared with that obtained without treatment in Comparative Example 2.

### Example 16

100 parts by weight of urethane resin decomposed substance A and 10 parts by weight of sodium benzoate were mixed, and heated at 150° C. for 60 minutes using an oil bath. The product was mixed with apolyol mixture (hydroxyl group value=381 mg KOH/g) used as a raw material of a urethane resin for refrigerator heat insulation material, at mixture ratio (wt. % based on total amount) shown in Table 7. To 100 parts by weight of the resulted mixture was added 90 parts by weight of a polymeric MDI-based isocyanate mixture (% NCO=31.4) used as a raw material of a urethane resin for refrigerator heat insulation material, and the mixture was stirred at high speed to produce a foam, and rise time in this operation was measured. The resulted value is shown in Table 7.

The rise time, which indicates reaction time, elongated significantly, and thus could suppress reactivity, as compared with that obtained without treatment in Comparative Example 2.

### Example 17

100 parts by weight of urethane resin decomposed substance A and 10 parts by weight of salicylic acid were mixed, and heated at 150° C. for 60 minutes using an oil bath. The product obtained was mixed with a polyol mixture (hydroxyl group value=381 mg KOH/g) used as a raw material of a urethane resin for refrigerator heat insulation material, at mixture ratio (wt. % based on total amount) shown in Table 7. To 100 parts by weight of the resulted mixture was added 90 parts by weight of a polymeric MDI-based isocyanate mixture (% NCO=31.4) used as a raw material of a urethane resin for refrigerator heat insulation material, and the mixture was stirred at high speed to produce a foam, and rise time in this operation was measured. The resulted value is shown in Table 7.

The rise time, which indicates reaction time, elongated significantly, and thus could suppress reactivity, as compared with that obtained without treatment in Comparative Example 2.

TABLE 7
Mixture Ratio of Rise time (second)

| Decomposed | | | | | |
|---|---|---|---|---|---|
| Substance | Exp. 13 | Exp. 14 | Exp. 15 | Exp. 16 | Exp. 17 |
| 20 wt. % | 262 | 246 | 312 | 238 | 312 |
| 30 wt. % | 136 | 141 | 168 | 134 | 186 |
| 40 wt. % | 67 | 62 | 114 | 52 | 134 |
| 50 wt. % | 33 | 31 | 35 | 29 | 97 |

What is claimed is:

1. A method of treating a urethane resin, comprising:
decomposing a urethane bond of the urethane resin to obtain a resin decomposed substance, and
adding a treating agent to the resin decomposed substance, the treating agent being an acid anhydride or a compound having at least one group selected from the group consisting of a carboxyl group, salts thereof, esters thereof and haloformyl groups.

2. The method according to claim 1, wherein the decomposition is conducted by adding an amine compound or polyol compound to the urethane resin while heating at 100 to 300° C., and the addition of the treating agent is conducted at 300° C. or less.

3. The method according to claim 1, wherein the treating agent has at least one hydroxyl group.

4. The method according to claim 3, wherein the treating agent is lactic acid or salicylic acid.

5. The method according to claim 1, wherein the treating agent is selected from the group consisting of compounds having only one carboxyl group, salts thereof, and anhydrides obtainable through bonding by dehydration between two compounds each of which has only one carboxyl group.

6. The method according to claim 1, wherein the decomposition is conducted in a process of extruding the urethane resin charged in an extruder out of the extruder.

7. A composition for recycling a urethane resin, comprising a reaction product obtainable by reacting an amino group contained in a resin decomposed substance with a treating agent, wherein the resin decomposed substance is an intermediate product prepared by decomposing a urethane bond in the urethane resin, and the treating agent is an acid anhydride or a compound having at least one group selected from the group consisting of a carboxyl group, salts thereof, esters thereof, and haloformyl groups.

8. The composition according to claim 7, wherein the treating agent has at least one hydroxyl group.

9. The composition according to claim 8, wherein the treating agent is lactic acid or salicylic acid.

10. The composition according to claim 7, wherein the treating agent is selected from the group consisting of compounds having only one carboxyl group, salts thereof, and anhydrides obtainable through bonding by dehydration between two compounds each of which has only one carboxyl group.

11. A method of regenerating a resin from a urethane resin, comprising:
decomposing a urethane bond in the urethane resin to obtain a resin decomposed substance;
adding a treating agent to the resin decomposed substance, to obtain a composition for recycling, the treating agent being an acid anhydride or a compound having at least one group selected from the group consisting of a carboxyl group, salts thereof, esters thereof, and haloformyl groups; and
adding an epoxy resin or isocyanate compound to the composition for recycling, to regenerate a resin.

12. The method according to claim 11, wherein the decomposition is conducted by adding an amine compound or polyol compound to the urethane resin while heating at 100 to 300° C., and the addition of the treating agent is conducted at 300° C. or less.

13. The method according to claim 11, wherein the treating agent has at least one hydroxyl group.

14. The method according to claim 13, wherein the treating agent is lactic acid or salicylic acid.

15. The method according to claim 11, wherein the treating agent is selected from the group consisting of compounds having only one carboxyl group, salts thereof, and anhydrides obtainable through bonding by dehydration between two compounds each of which has only one carboxyl group.

16. The method according to claim 11, wherein the decomposition is conducted in a process of extruding the urethane resin charged in an extruder out of the extruder.
